(19) United States
(12) Patent Application Publication
(10) Pub. No.: US 2017/0046805 A1
(43) Pub. Date: Feb. 16, 2017

(54) Lawyer App

(71) Applicant: Salman Al-Saud, Lowell, MA (US)

(72) Inventor: Salman Al-Saud, Lowell, MA (US)

(21) Appl. No.: 14/823,139

(22) Filed: Aug. 11, 2015

(51) Int. Cl. G06Q 50/18; G06F 3/0481; G06F 3/0484; H04L 29/08

(52) U.S. Cl. CPC G06Q 50/18; H04L 67/306; G06F 3/0481; G06F 3/0484

(57) ABSTRACT

Disclosed herein is a computer implemented system and method for acquiring and providing service using an electronic device, particularly personalized for legal industry. The invention provides a user with a system and method for hiring a personal or an organization to advising and assisting the user in legal matters. In one embodiment the system and method provides a user with a list of lawyer profile on a query based on a plurality of filters like academic information, professional information, geographical location, type of law practiced, percentage of successful and unsuccessful cases, service-charge charged etc. The computer implemented system and method for acquiring and providing service using an electronic device uses a Graphical User Interface (GUI).

### CROSS REFERENCE TO RELATED APPLIACTIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention concerns systems and method of acquiring and providing service, tailored for particular industries, such as the legal industry.

(2) Background

A key aspect of the American legal system (as well as many others around the world) is its reliance on professional advocates, or lawyers, to facilitate adjudication or avoidance of legal disputes. Indeed, one of the constitutional rights that we as Americans cherish most dearly is the right to counsel. Thus, when confronted with a legal issue, one of the first questions that prudent businesses and individuals seek to answer is which attorney or law firm will assist them with expert legal advice and advocacy.

In recent years, many facing this question have sought to use the power of the Internet as a tool in identifying and/or selecting effective counsel for their legal needs, For example, many use general search engines, such as www.Google.corn or www,Yahoo.corn, to broadly search the World Wide Web for lawyers based on location and particular legal expertise. Others rely on legally focused resources, such as v.findlaw.corn, which provides and maintains an extensive directory of law firms and legal professionals.

One of the greatest difficulties for attorneys and other professionals (such as medical doctors and accountants) in establishing their practice is obtaining a client base or client network that is capable of providing them with a sufficient level of work on a regular basis. The problem is especially acute with attorneys, as ethics regulations promulgated by the bars of each of the states limit an attorney's ability to advertise and solicit potential clients.

Historically, attorneys have relied on networking with clients, other professionals, and other attorneys to generate referrals Often, the most successful lawyers are those that are not necessarily the best at their craft, but those that are best at networking or developing relationships. These rainmakers are often also among the oldest attorneys at a firm.

To help lawyers, especially those that are solo practitioners or with a small firm, acquire new clients a number of lawyer listing sites have appeared in the past 10 years or so. Typically, these sites provide regional listings of attorneys in particular categories of practice, Several of these sites claim to screen the attorneys that are listed on their sites. Some examples include Fincllaw.corn and Lawyers corn These types of sites are most often no more than online directories, analogous to the Yellow Pages. Since the information concerning the listed attorneys are usually available to anyone with internet access, an attorney receiving an inquiry from someone must spend his/her valuable time or an administrative assistant's time screening the person to determine whether or not the inquirer is serious about hiring an attorney or just fishing for free advice.

There are other online sites wherein a person looking for legal representation provides a description of the representation he/she requires and solicits inquiries from attorneys. Some of these sites may require the attorney to provide a quote concerning how much he/she will charge to perform the legal work. Usually, the attorney will only have limited information about the prospective client to judge whether or not to provide a proposal. Furthermore, the nature of the process tends to attract clients who are shopping for legal services primarily on price rather than quality, and many attorneys, especially the better ones, cannot reasonably provide the solicited legal services for as low a price as would be required to “win” the client

A system is desirable that will receive queries from users regarding a legal topic and responds with a listing of attorneys or law firms that are associated with information, ranking them based on their experience in handling matters related to the legal topic.

### BRIEF SUMMARY OF THE INVENTION

Primarily, the invention is a computer implemented method of acquiring and providing of service using an electronic device.

The method includes a creation of at least one user account by a user wherein the user account associated with a service and the user uses said user account to act as a potential consumer and/or a potential service provider; providing a Graphical User Interface (GUI) using which the user uses the service; creating and integrating the user into a computing based community comprising plurality of the users; using, curating, processing and presenting the user's related data and actions using at least one user account; creating at least one profile by a potential service provider for conveying said potential service provider's information comprising academic information professional information, social information and achievements and like; uploading at least one profile by a potential service provider over the computing based community; acquiring at least one information about the required potential service provider from potential consumer using the service; sharing at least one profile over the computing based community based on at least one information acquired from the potential consumer to be viewed by other users wherein the other users comprises a potential consumer; sending an employment offer from the potential consumer to the potential service provider; acquiring an acceptance of the employment offer from the potential consumer using the service; acquiring a confirmation of completion of a job associated with the employment offer from the potential service provider using the service; acquiring a confirmation of completion of the job from the potential consumer using the service; acquiring a rating of satisfaction from the potential consumer about the potential service provider performance associated with the job using the service; acquiring a rating of satisfaction from the potential service provider about the potential service provider's experience in working with the potential consumer using the service; using the rating of satisfaction from the potential consumer about the potential service provider's performance for rating the potential service provider; creation and/or uploading and sharing at least one profile over the computing based community by the potential service provider to convey the potential service provider's unique qualitative assets for employability, using the potential service provider's user account; creation and/or uploading and sharing at least one profile over the computing based community by the potential consumer to convey the potential consumer's requirement for potential service providers required for an associated job, using the potential consumer's user account; using a geo-location parameter for associating the potential service provider's geographic location information to categorize the potential service provider's availability for a particular job and providing the geographic location information on the potential service provider's account.

In the method, said service facilitates interaction and communication between all users integrated. It is not mandatory for said plurality of users to have accounts with the service. However, said plurality of users who do not have accounts associated with the service will have limited/restricted scope of actions and interaction in the computing based community. The user uses said at least one set of contacts to interact and communicate with a plurality of other users integrated into the computing based community and the interaction and communication is video-based.

According to the method of the invention at least one profile of the potential service provider's conveys unique qualitative assets for employability that is made available for the viewing of a plurality of other users integrated into the computing based community using the potential service provider's account. Also at least one profile conveys the requirement of said potential consumer's for the viewing of a plurality of other users integrated into the computing based community using said potential consumer's account.

Further according to the method rating of satisfaction provided from the potential consumer for rating the potential service provider comprises of implementing an algorithm for ranking the potential service provider wherein the ranking is done on a geographic location basis.

In a preferred embodiment of the invention the service provided is legal guidance and/or assistance to said potential consumers, the potential consumer is service seeking legal guidance and/or assistance and the potential service provider is a lawyer and/or a law firm providing legal guidance and/or assistance.

In another preferred embodiment, the invention is a computer implemented system for acquiring and providing of information pertaining to legal services. The system involves a graphical user interface for acquiring at least one query regarding lawyers from at least one client access device such as a cellphone, smartphone, PDA, etc.; a database containing information regarding the plurality of lawyers profiles; and a server configured to receive queries regarding lawyers from at least one client access device, to output information retrieved from the database to the client access device, the information comprises of a list of two or more lawyer profile contained in the database, where each of the lawyer profile is associated with a rank based on legal experience of the named lawyer.

In the invention, the system query comprises of academic information, professional information and geographical location. Also, the system further has a feature that provides a ranking that is based on a jurisdiction of a lawyer, geographic distance of the lawyer for the user using the client access device, the percentage of successful and unsuccessful cases managed by the lawyer and/or the service-charge charged by the lawyer. The client access device includes a display screen, and the server is configured to output the list of two or more lawyer names as part of a graphical user interface for display on the display screen.

Furthermore, the server is configured to respond to the user selection of one of the listed lawyer names to display a listing of one or more other lawyer names that are professionally associated with the selected lawyer name. The client access device includes a display screen, and the server is configured to output the list of two or more lawyer names as part of a graphical user interface for display on the display screen, with each of the lawyer names associated with a hyperlink to cause the display of a corresponding lawyer profile.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosures For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWING

The drawings constitute a part of this specification, and include exemplary embodiments to the invention, which may be embodied in various forms. It is to be understood that, in some instances, various aspects of the invention may be shown exaggerated or enlarged to facilitate an understanding of the invention.

FIG. 1 illustrates the prospective view of invention, with various components of the client access device.

### DETAILED DESCRIPTIONS OF THE INVENTION

The following is a detailed description of example embodiments of the invention that is depicted in the accompanying drawings. The example embodiments are in such detail as to clearly communicate the invention However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to)—multi-purpose pocket computers, personal multimedia devices, etc.

The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but are not limited to) touch-pads, such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar. 21, 2006); (3) U.S. patent application Ser. No: 08/210,610 (“Computer system with touchpad support in operating system”, filed Mar. 18, 1994); (4) U.S, patent application Ser. No. 643,256(“Movable touch pad with added functionality”, filed Ser. No. 10/643,256), touch screens such as those described in(but not limited to) (1) U.S. patent application Ser. No. 11/381,313, “Multipoint Touch Surface Controller,” filed on May 2, 2006 ; (2) U.S. patent application Ser. No. 10/840,862, “Multipoint Touchscreen,” filed on May 6, 2004 ; (3) U.S. patent application Ser. No, 10/903,964, “Gestures For Touch Sensitive input Devices,” filed on Jul. 30, 2004; (4) U.S. patent application Ser. No. 11/048,264, “Gestures For Touch Sensitive Input Devices,” filed on Jan. 31, 2005 ; (5) U.S. patent application Ser. No. 11/038,590, “Mode-Based Graphical User Interfaces For Touch Sensitive Input Devices,” filed on Jan. 18, 2005 ; (6) U.S. patent application Ser. No. 11/228,758, “Virtual Input Device Placement On A Touch Screen User Interface,” filed on Sep. 16, 2005 ; (7) U.S. patent application Ser. No. 11/228,700, “Operation Of A Computer With A Touch Screen Interface,” filed on Sep. 16, 2005 ; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006 , keyboards, such as those mentioned in(but not limited to) U.S. patent application Ser. No. 07/711,760 (“Ergonomic keyboard input device” , filed on Jun. 6, 1991) , mouse, such as those described in (but not limited to) (1) application Ser. No. 09/167,314 (“Computer mouse with enhance control button (s)”, filed on Oct. 6, 1998); (2) application Ser. No. 08/288,945 (“Roller mouse for implementing scrolling in windows applications”, filed on Aug. 10, 1994) and gesture recognition means, such as those described in(but not limited to) (1) European Patent application publication number; EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic devices.

Connectivity of these devices with networks, such as the internet, an intranet and/or wireless network, such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document.

The present invention maybe implemented on applications that run on a single or variety of operating system platforms, including but not limited to OS X, WINDOWS, UNIX, IOS, ANDROID, SWABIAN, LINUX, or embedded operating systems, such as VxWorks.

The present invention may also be implemented to work with various web browsers, including but not limited to Internet Explorer, Mozilla Firefox, Safari, and Opera, that access and handle various types of web pages constructed with various mark- up languages, such as HTML, HTML-5, XHTML, XML, etc. and the associated CSS (cascading style sheet) files and java-script files.

The method involves creation of at least one user account by a user wherein said user account is associated with a service and said user uses said user account to act as a potential employee and/or a potential employer.

The user account is created by collecting various information associated with said user such as (but not limited to) personal information, professional information, financial information and information associated with other social computing services. Personal information involves details (but not limited to) a user's name, age, sex, address, phone number, fax number, email id, etc. Professional information involves details like(but not limited to) academic details, area of professional expertise, achievements and awards, currently pursuing projects, present and past place/organization/company of work, researches and publications, etc. Service charge details may involve details regarding (but not limited to)a time -period based (hours, weeks, months, etc.) rates for service, etc. All information associated to said user is presented in a “profile” in said user account.

The method also involves integrating said user into a computing based community comprising a plurality of users. The computing based community is a network that connects the registered users the service, provides means of communication and interaction between them and provides information associated with each user in their accounts. The method involves using, curating, processing and presenting a user's related data and actions using the user's at least one user account. A user can connect to, communicate and interact with other users in said computing based community using said service. Said service is a software application and/or service that comprises both online as well as offline aspects. The method involves providing a Graphical User Interface (GUI) using which said user uses said service.

The method also involves creation of at least one profile by a potential service provider for conveying said service provider's information comprising academic information, professional information, social information, personal information and achievements.

The method also involves sharing said at least one profile over a network so that they can be viewed by other users in said computing based community wherein other users comprises a potential consumer. A potential employer can view these profiles and get a full idea of the user's academic information, professional information, social information, personal information and achievements. If the potential consumer is convinced that the user satisfies his criteria and need for a service provider, the method further comprises sending an employment offer from said potential consumer to said user (potential service provider). Sending said employment offer can be in the form of an employment offer or it can be done by using the GUI provided by said service.

The method then involves acquiring an acceptance of said employment offer from said potential consumer. Acquiring the acceptance can either be in the form of an employment offer or it can be done by using the GUI provided by said service.

After a confirmation of job from both potential consumer as well as potential service provider is acquired, the method involves acquiring a rating of satisfaction from said potential consumer about said potential service provider's performance associated with said job and using said rating of satisfaction from said potential consumer about said potential service provider's performance for rating said potential service provider.

The method also involves acquiring a rating of satisfaction from said potential service provider about said potential service provider's experience in working with said potential consumer and using said rating of satisfaction from said potential service provider about said potential service provider's experience in working with said potential consumer for rating said potential consumer. Ratings can be presented using various rating scales such as those classified as—data measured at the ordinal level wherein numbers indicate the relative position of items, but not the magnitude of difference, for example, Likert scale; data are measured at the interval level wherein numbers indicate the magnitude of difference between items but there is no absolute zero point, for example, attitude scales and opinion scales; and data measured at the ratio level wherein numbers indicate magnitude of difference and there is a fixed zero point and ratios can be calculated. The method further comprises using said rating of satisfaction from said potential consumer for implementing an algorithm for ranking said potential service provider wherein said ranking is made on a geographic location basis. According to the ranking, a potential service provider is categorized into a number of levels to give a potential consumer an idea of the level of expertise and experience of a potential service provider with respect to a particular profession. The potential service providers who move up the ranks into the top levels may be referred to as “rising” and a list of rising potential service providers maybe provided to a potential consumer on demand.

The method further involves creation and/or uploading and sharing at least one profile over said computing based community by said potential consumer to convey said potential consumer's requirement for potential service providers required for an associated job, using said user account.

The method further involves using a geo-lo ation parameter for associating said potential consumer's geographic location information to categorize said potential service provider's availability for a particular job and providing said geographic location information on said potential employee's account. Said geo-location parameter is obtained from Global Positioning System (GPS) embedded in an electronic device. Availability of a potential service providers can also be provided based on their online status and potential uses that are online at a particular time are referred to as “live” potential service providers.

The service associated with the computing based community provides a user to search for results using filters. These filters may be used to narrow down search results specific to(but not limited to) geographic location, categories/key words relating to the job description, relation of the search results with the user ,nature of the job, job experience current employment status tags, rising, ratings, user name and profile me.

Filters specific to geographic location may be fields such as(but not limited to) name of country, state, city, neighborhood/locality. Filters specific to categories/key words relating to the job description are(but not limited to) law, music, entertainment, advertising, performance, magic, comedy, film making, model, massage, software engineer, babysitter, domestic help, TV, event management, graphic designer, etc.

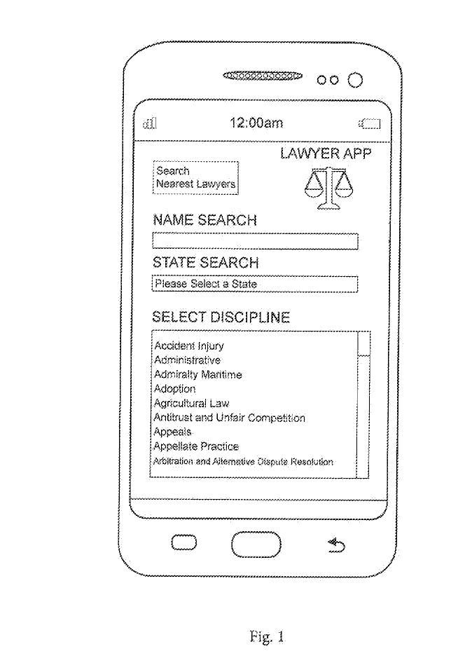

FIG. 1 illustrates the graphical user interface that is displayed in the display (102) of the client access device that receives queries from users regarding a legal requirement like type of lawyer (divorce lawyer, corporate lawyer and like), experience of a lawyer, state/country where the legal assistance is required etc. and responds with a listing of attorneys or law firms that are associated with information, while also ranking them based on their experience in handling matters related to the legal requirement.

According to the invention, different options will be provided via the graphical user interface for the customer to choose from using the navigation buttons. The customer would have to put in their budget, what type of lawyer (divorce, corporate, Child Support, etc.), country/state lawyer rating, law firm, and experience. After that, according to what the customer put in his/her search box, the results will show different lawyers that are qualified for the job. The customer will have the opportunity to choose the lawyer they want.

However, when a customer creates an account, they will have to verify their phone numbers and email. Also, both customer and lawyer would have to create an account in the application. People would have limited and/or restricted scope of actions and interaction with the computing based application unless they have an account. Furthermore, different criteria that would be used to determine the best suited lawyer for the customer, such as their rating, the nearest lawyer, experience, percentage of wins to loses, and their service charges. The customer would be able to view the information about the lawyer in order to make the best choice for him or herself. Lawyers would be able to advertise their services according to their profile requirement. The lawyer's email and phone number will not appear on his/her profile. If the customer is ready to “hire” the lawyer of their choice, they can press a button, which will allow the lawyer to view their case and information. Other than that, the customer's information is private. Moreover, the application will have its own database. Lawyers will have to sign up and create a profile from them. Law firms could join the application to find customers. In their profiles, lawyers can include what firm they work for, and law firms can recommend their best lawyers in the application. The firm would have a rating on how good it is from the customer satisfaction.

The invention is a computer implemented system for acquiring and providing of information pertaining to legal services The system involves a graphical user interface for acquiring at least one query regarding lawyers from at least one client access device such as a cellphone, srnartphone, PDA, etc.; a database containing information regarding the plurality of lawyers profiles; and a server configured to receive queries regarding lawyers from at least one client access device, to output information retrieved from the database to the client access device, the information comprises of a list of two or more lawyer profile contained in the database, where each of the lawyer profile is associated with a rank based on legal experience of the named lawyer.

In the invention, the system query comprises of academic information, professional information and geographical location. Also, the system further has a feature that provides a ranking that is based on a jurisdiction of a lawyer, geographic distance of the lawyer for the user using the client access device, the percentage of successful and unsuccessful cases managed by the lawyer and/or the service-charge charged by the lawyer. The client access device includes a display screen and the server is configured to output the list of two or more lawyer names as part of a graphical user interface for display on the display screen.

Furthermore, the server is configured to respond to the user selection of one of the listed lawyer names to display a listing of one or more other lawyer names that are professionally associated with the selected lawyer name. The client access device includes a display screen, and the server is configured to output the list of two or more lawyer names as part of a graphical user interface for display on the display screen, with each of the lawyer names associated with a hyperlink to cause the display of a corresponding lawyer profile.

The computer implemented system and method provide both, the consumer with a large list of service provider that can be conveniently contacted as per the preference of the consumer and a service provider with a larger amount of client with a variety of requirements thereby providing a profitable business aspect.The lawyers are to be employed through the computer implemented method, however, a fee is to paid by both the consumer and the service provider for example the client seeking legal assistance from a lawyer.

Although specific embodiments have been illustrated and described herein, it will be appreciated by those of ordinary skill in the art that any arrangement that is calculated to achieve the same purpose may he substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention

I claim:

1. A computer implemented method of acquiring and providing of service using an electronic device comprising:
creation of at least one user account by a user wherein said user account is associated with a service and said user uses said user account to act as a potential consumer and/or a potential service provider;
providing a Graphical User Interface(GUI) using which said user uses said service;
creating and integrating said user into a computing based community comprising plurality of said users;
using, curating, processing and presenting said user's related data and actions using said at least one user account;
creating at least one profile by a potential service provider for conveying said potential service provider's information comprising academic information, professional information, social information and achievements and like;
uploading said at least one profile by a potential service provider over said computing based community;
acquiring at least one information about the required potential service provider from said potential consumer using said service;
sharing said at least one profile over said computing based community based on said at least one information acquired from said potential consumer to be viewed by other users wherein said other users comprises a potential consumer;
sending an employment offer from said potential consumer to said potential service provider;
acquiring an acceptance of said employment offer from said potential consumer using said service;
acquiring a confirmation of completion of a job associated with said employment offer from said potential service provider using said service;
acquiring a confirmation of completion of said job from said potential consumer using said service;
acquiring a rating of satisfaction from said potential consumer about said potential service provider performance associated with said job using said service;
acquiring a rating of satisfaction from said potential service provider about said potential service provider's experience in working with said potential consumer using said service;
using said rating of satisfaction from said potential consumer about said potential service provider's performance for rating said potential service provider;
creation and/or uploading and sharing at least one profile over said computing based community by said potential service provider to convey said potential service provider's unique qualitative assets for employability, using said potential service provider's user account;
creation and/or uploading and sharing at least one profile over said computing based community by said potential consumer to convey said potential consumer's requirement for potential service providers required for an associated job, using said potential consumer's user account;
using a geo-location parameter for associating said potential service provider's geographic location information to categorize said potential service provider's availability for a particular job and providing said geographic location information on said potential service provider's account.

2. The method according to claim 1, wherein said service facilitates interaction and communication between all users integrated into said computing based community.

3. The method according to claim 1, wherein said plurality of users have accounts associated with said service.

4. The method according to claim 1,wherein acquiring said acceptance of employment offer from said potential service provider is achieved using said User Interface (GUI) provided by said service.

5. The method according to claim Lwherein acquiring said confirmation of completion of said job associated with said employment offer from said potential service provider is achieved using said Graphical User Interface (GUI) provided by said service.

6. The method according to claim 1,wherein acquiring said confirmation of completion of said job from said potential consumer is achieved using said Graphical User Interface (GUI) provided by said service.

7. The method according to claim 1, wherein acquiring said rating of satisfaction from said potential consumer about said potential service provider's performance associated with said job is achieved using said Graphical User Interface (GUI) provided by said service.

8. The method according to claim 1,wherein said acquiring a rating of satisfaction from said potential service provider about said potential service provider's experience in working with said potential consumer is achieved using said Graphical User Interface (GUI) provided by said service.

9. The method according to claim 1, wherein said at least one profile to convey said potential service provider's unique qualitative assets for employability is made available for viewing to a plurality of other users integrated into said computing based community using said potential service provider's account.

10. The method according to claim 1, wherein said at least one profile to convey said potential consumer's requirement for potential service providers is made available for viewing to a plurality of other users integrated into said computing based community using said potential consumer's account.

11. The method according to claim 1, wherein said at least one profile for conveying said user's information is made available for viewing to a plurality of other users integrated into said computing based community using said user's account.

12. The method according to claim 1, wherein using said rating of satisfaction from said potential consumer for rating said potential service provider further comprises implementing an algorithm for ranking said potential service provider wherein said ranking is done on a geographic location basis.

13. The method according to claim 1, wherein said service provides legal guidance and/or assistance to said potential consumers.

14. The method according to claim 1, wherein potential consumer is a user of said service seeking legal guidance and/or assistance.

15. The method according to claim 1, wherein potential service provider is a lawyer.

16. The method according to claim 1, wherein potential service provider is a law firm.

17. A computer implemented system for acquiring and providing of information pertaining to legal services, system comprising:
a graphical user interface for acquiring at least one query regarding lawyers from at least one client access device
a database containing information regarding said plurality of lawyers profiles; and
a server configured to receive said query regarding lawyers from said at least one client access device, to output to said client access device a list of two or more lawyer profile contained in the database, with each of said lawyer profile is associated with a rank based on legal experience of said named lawyer.

18. The system as set forth in cla im 17, wherein said at least one query comprises of academic information and/or professional information.

19. The system as set forth in claim 17, wherein said rank is based on type of law practiced by said lawyer.

20. The system as set forth in claim 17, wherein said rank of said lawyer profile is based on the percentage of successful and unsuccessful cases managed by said lawyer.

21. The system as set forth in claim 17, wherein said rank is based on service-charge charged by said lawyer.

22. The system as set forth in claim 17, wherein said rank is based on a jurisdiction of said lawyer.

23. The system as set forth in claim 17, wherein said rank is based on geographic distance of a lawyer from said client access device generating said query.
